(19) United States
(12) Patent Application Publication
(10) Pub. No.: US 2007/0151139 A1
(43) Pub. Date: Jul. 5, 2007

(54) TURKEY DECOY

(76) Inventor: Kyle Douglas O'Dell, Fort Smith, AR (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 11/619,400

(22) Filed: Jan. 3, 2007

Related U.S. Application Data
(60) Provisional application No. 60/757,111, filed on Jan. 5, 2006.

(51) Int. Cl. A01M 31/06

(52) U.S. Cl. 43/2

(57) ABSTRACT

A decoy for turkey hunting utilizes a detachable turkey fan which reproduces the coloration of a natural male turkey fan to enhance the perception by wild turkeys that an interloper turkey is in the territory. A second decoy simulating a female is included in the kit.

### CROSS-REFERENCE TO RELATED APPLICATION

This application claims the benefit of U.S. Application No. 60757,111, Filed Jan. 5, 2006, the contents of which are hereby incorporated by reference.

### FIELD OF THE INVENTION

The present invention relates generally to the field of decoys and more particularly to decoys for attracting wild turkeys to a desired location. With even greater particularity, the present invention relates to decoys for attracting male wild turkeys.

### BACKGROUND OF THE INVENTION

A primary objective in the art of decoys is that the decoy attract the desired game species to the decoy for purposes of observation, wildlife management, or for hunting. The most successful decoys are those that stimulate the senses or instincts of the desired game to evoke a response to approach within close proximity to the decoy.

Generally, a decoy will depict members of the same species as the desired game animal such that the game's familiarity with and close association with other members of its species will attract them to each other. In this sense, the decoy artisan will exploit the game's communal instincts to attract the game animal, and perhaps make the animal less wary of its surroundings. Similarly, game animals may be decoyed by exploiting the animal's breeding instincts.

With game animals such as birds, many of their courting rituals are highly visual with the male of the species generally having vivid colorations and other displays to attract a female mate. The male wild turkey, or tom, is known for its spectacular display fan as it extends the plumage of its tail feathers during its courting ritual where it will strut about and ruffle its feathers in order to attract a receptive female. Wild turkeys are also communal animals in which the hierarchy of the flock is established according to an established pecking order. In this regard, a tom's display fan may also serve as an indication of aggression as competing males attempt to establish their dominance within the flock. Once established, the pecking order particularly holds when it comes to breeding habits wherein the dominant male will aggressively suppress breeding activities of the subordinate toms within the flock.

With wild turkeys, a female or hen, will indicate her receptiveness to breeding by assuming a submissive position in front of the male characterized by a crouch position with the neck erect and the head held perpendicular to the ground. In this regard, it is the hen that chooses the tom in response to the courting strut and display exhibited by the male.

Wild turkeys are well known for their visual acuity in detecting the slightest movements, which may in part explain the ruffling and strutting that are characteristic of the tom's courtship dance and the effectiveness of its display fan when assuming an aggressive posture. As the dominant toms are often prized by avid turkey hunters, it is desirable that a decoy for attracting the same take advantage of these aforementioned characteristics. Moreover, as the intended use of the decoy is contemplated in a wilderness environment and a suitable location will likely require the operator to carry the decoy to its intended site, it is desirable that the decoy be lightweight, and readily carried by the operator.

### BRIEF SUMMARY OF THE INVENTION

The present invention comprises a decoy for attracting turkeys to a desired point for observation or for hunting the same. The decoy comprises a main body depicting a male turkey. The main body further comprises a slot defined transverse the main body proximal the tail end thereof. The slot is adapted to receive an insert depicting a display fan for a male turkey. The insert may be a simulated display fan, such as a sheet imprinted with a depiction of a male turkey display fan on its front and back surfaces. More preferably, the insert comprises a natural display fan harvested from a male turkey.

The main body may be substantially hollow and is preferably suspended from a pivot point located near the center of gravity of the main body such that the decoy may exhibit movement in response to a disturbance, such as a breeze or mechanical stimuli, in order to enhance perception of the decoy by the targeted game. For improved performance of the decoy in attracting turkeys, and more specifically a dominant male turkey, a second main body depicting a female turkey, and more preferably a female turkey poised in its receptive breeding posture, is provided and positioned in close proximity to the main body of the male turkey decoy.

### BRIEF DESCRIPTION OF THE SEVERAL VIEWS OF THE DRAWINGS

FIG. 1 depicts a perspective view of a body portion for a decoy generally depicting a male turkey;

FIG. 2 depicts a simulated tail feather display for a male turkey;

FIG. 3 depicts a body portion for a male turkey decoy with the simulated tail feather display inserted in the main body portion;

FIG. 3 depicts an exemplary body portion for a decoy depicting a female turkey;

FIG. 4 depicts a typical deployment of a male and female turkey decoy; and

FIG. 5 depicts a natural display fan.

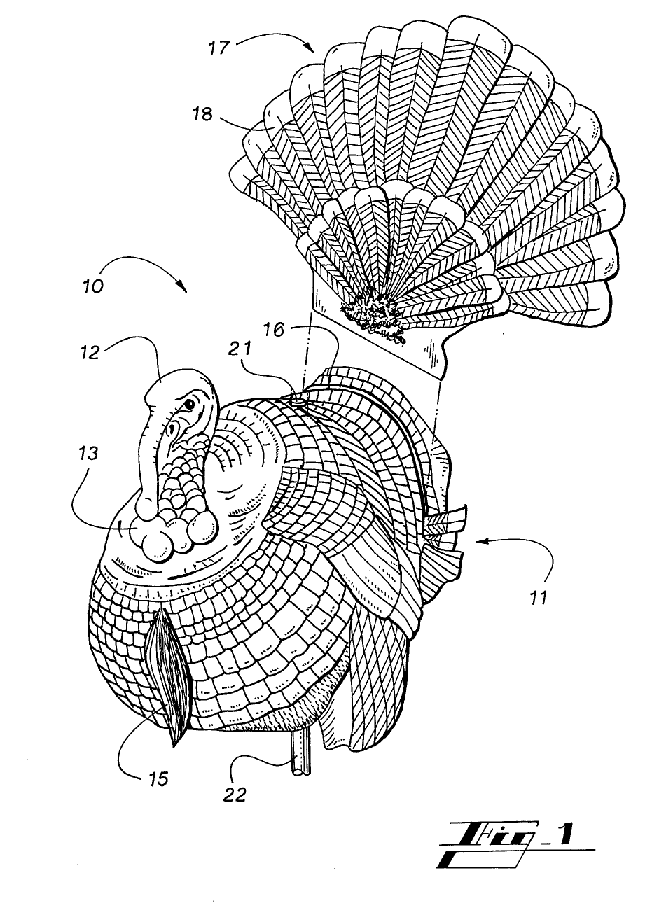

### DETAILED DESCRIPTION OF THE INVENTION

In reference to the several drawings which form part of the disclosure of the invention, the present invention comprises a decoy for attracting turkeys to a desired point for purposes of observation, wildlife management, or for hunting the same. The decoy 10 comprises a main body 11 depicting a male turkey. More preferably, the main body 11 will be shaped to simulate the posture and markings of a male turkey engaged in its characteristic courting strut, such that the neck holds the head erect and drawn towards the back and its feathers are flushed outwardly. The head 12 and wattle 13 coloration are a combination of blue, red, and white and more preferably the white will predominate to simulate a male in an increased state of excitement in anticipation of mating. The feathers should be darkly colored, with the tips having characteristic markings for the desired species or sub-species. As the feathers in the intermediate section of a tom's body have an iridescent bronze or copper tint, depending on the sub-species, the intermediate portion 14 of the main body 11 should be similarly colored, preferably with a paint applied to the surface of the main body 11. The body markings may be matched to a particular sub-species or regional differences in sub-species markings. The beard 15 of a mature tom prominently extends below the neck and wattle 13.

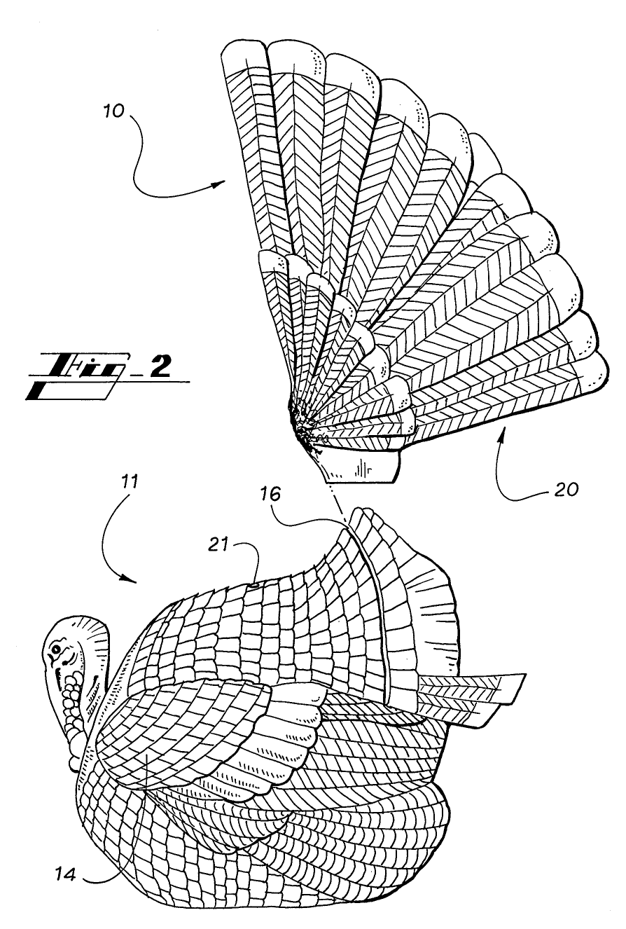

As may be seen best in reference to FIG. 2, the main body 11 further comprises a slot 16 defined transverse the main body 11 proximal the tail end thereof. The slot 16 is adapted to receive a display fan 17 in the form of an insert depicting a display fan for a male turkey. The insert may be a simulated display fan, such as a sheet material painted or imprinted with a depiction of a male turkey display fan on its front 18 and back 19 surfaces. The inventors have found that a semi-rigid flexible plastic sheet is well suited as it is lightweight, durable, and will readily accept the imprinted display fan. More preferably, the sheet should be imprinted with a photographic image of a male turkey display fan such that the front surface 18 accurately depicts the forwardly facing display of a tom and the back surface 19 depicts the rearwardly facing display as there are typically differences between the two. It should be noted that the display fan 17 may also be removably attached to the body in a suitable manner other than by insertion into the slot.

More preferably, the insert comprises a natural display fan 20 harvested from a male turkey as it will best present the coloration, markings, and textures of a turkey. The natural display fan 20 is prepared according to conventional methods. The tail feathers of a harvested mature tom are detached from the body and maintained in a spread arrangement as the residual flesh retaining the feathers in position is cured. Slot 16 in main body 11 should be of sufficient width so that it is capable of receiving the natural display fan 20. A natural display fan 20 has the advantage in that it may be harvested locally and may be selected to correspond to the unique markings of the desired sub-species of interest and will account for regional differences between sub-species. As an added advantage, particularly for a hunter who frequents a particular locale, the markings on the natural display fan 20 will correspond with the unique markings of a tom formerly belonging to a particular flock and may even be recognized as such by the surviving members of that flock according to its established place in the pecking order, adding to the overall effectiveness of the decoy 10.

As previously described, it is preferable that the decoy 10 be light weight so that it may be readily transported by the person emplacing the decoy 10. The decoy 10 should also be durable so that it will withstand the rigors of a wilderness environment. The inventors have also discovered that the decoy 10 should also be sufficiently durable to withstand attack by dominant male turkeys lured to the decoy 10 such that it should survive a spurring or pecking by an overly aggressive tom. The inventors have found that a suitable construction entails a molded substantially hollow main body 11. Plastics are a preferred material for providing durability, flexibility and adhesion of the pigments for the desired markings, though any suitable material may be utilized. If the selected material is sufficiently flexible, the slot 16 may be formed such that is considerably narrower than the would be otherwise possible with a rigid construction as the flexibility of the material will permit momentarily widening of the slot 16 in order that it may receive the considerable thickness of a natural display fan 20 as opposed to the somewhat narrower simulated display fan 17.

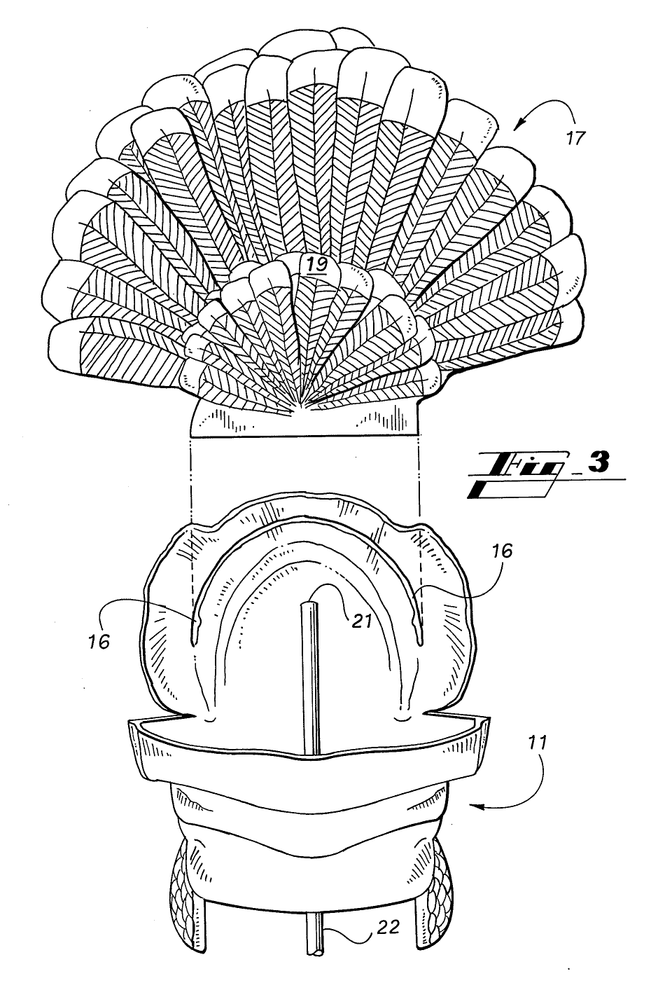

As best seen in reference to FIG. 3, the main body 11 is preferably suspended from a pivot point 21, such as a grommet or similar reinforced construction, located near the center of gravity of the main body 11. The main body 11 of the decoy 10 may be suspended on a stake 22 which is driven into the ground at the selected decoy site. A decoy 10 mounted by this method will permit movement of the decoy in response to a disturbance, such as a breeze or mechanical stimuli, to enhance perception of the decoy by the keen eyesight of the turkey and to simulate the strutting of a tom.

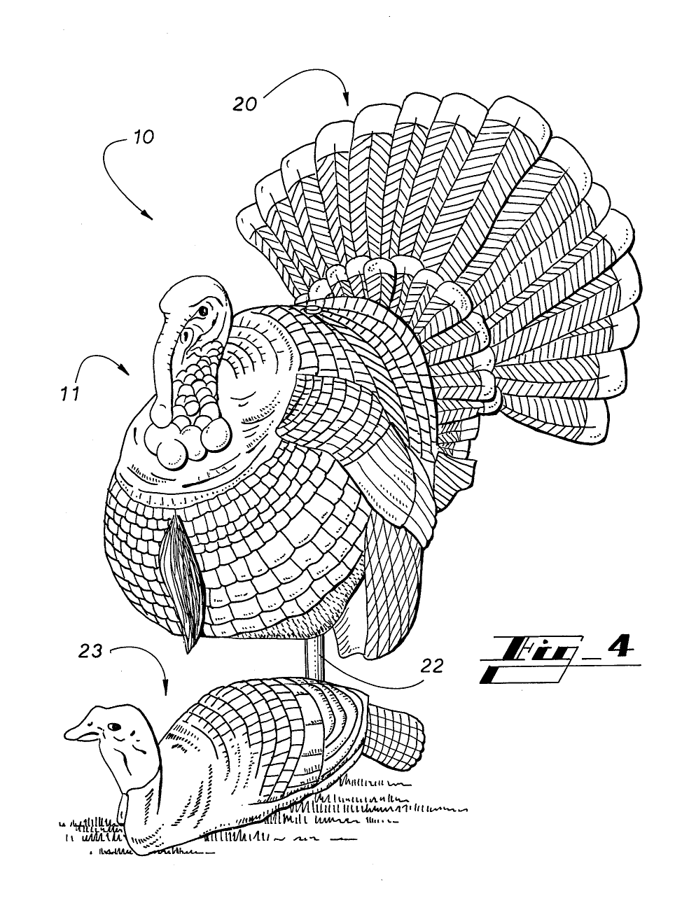

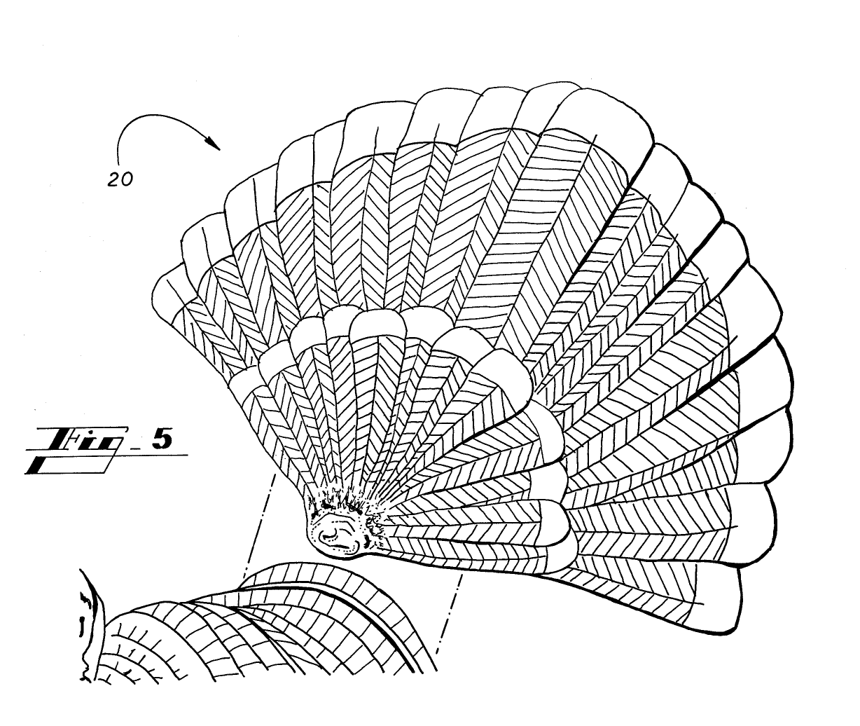

For improved performance of the decoy 10 in attracting turkeys, and more particularly dominant male turkeys, a second main body 23 is desirable. The second main body 23 should depict a female turkey, and more preferably a female turkey poised in its receptive breeding posture. As seen in reference to FIG. 4, the second main body 23 is emplaced on the ground in close proximity to the main body 11 of the male turkey, and positioned to indicate the female decoy's receptiveness to mating by the male decoy.

To facilitate transportability, stake 22 may be of a collapsible variety including a driven portion 23 having a point 24 at one end and a socket 25 at a second end. A second upper portion 26 has a socket 25 at its lower end and a pivot 27 at its upper end. The portions 23 and 26 are readily joined at their respective sockets 25. To avoid loss of the separate portions 23 and 26, they may be joined by an elastic chord or similar material attached near each of the respective sockets 25. To further facilitate transportability, main body 11, second main body 23, display fans 17 or 20 may be conveniently carried in a large bag. The bag should effectively mask the decoy 10 such that the transported decoy 10 and the person carrying the same are not mistakenly identified as a target by an unwary hunter. Alternatively, the bag should be brightly colored, such as in brightly colored hunter orange, so as to avoid inadvertent identification as live game.

It should be understood that although the inventors have described an exemplary embodiment of the invention, modifications and variations might be made without departing from the sprit of our invention. Accordingly, we claims as our invention all forms thereof coming within the scope of the appended claims.

What is claimed is:

1. A decoy comprising a main body depicting a male turkey and a slot defined transversely across said main body proximal a tail end of said main body.

2. The decoy of claim 1, wherein said slot is adapted to receive an insert depicting a display fan of male turkey.

3. The decoy of claim 2 wherein said slot receives said insert.

4. The decoy of claim 3 wherein said insert is a simulated display fan of a male turkey.

5. The decoy of claim 4 wherein said insert comprises a sheet of semi-rigid material shaped to a silhouette a display fan of a male turkey.

6. The decoy of claim 5 wherein said sheet is imprinted with a depiction of a male turkey display fan.

7. The decoy of claim 6 wherein said sheet is imprinted with a photographic reproduction of a male turkey display fan.

8. The decoy of claim 2 wherein said insert is a natural display fan of a male turkey.

9. The decoy of claim 1, wherein said main body is substantially hollow.

10. The decoy of claim 9, wherein a pivot point is defined near a center of gravity of said main body.

11. The decoy of claim 10, wherein said main body is suspended at said pivot point.

12. The decoy of claim 1 further comprising a second main body depicting a female turkey.

13. The decoy of claim 12, wherein said second main body is positioned proximal said main body.

14. The decoy of claim 12, wherein said second main body depicts a female turkey receptive to breeding by a male turkey.

15. A device for use with a turkey decoy having a main body depicting a male turkey comprising a simulated display fan of male turkey attachable to said decoy at a tail portion of said main body.

16. The device of claim 15, wherein said simulated display fan is a flexible material.

17. The device of claim 15, wherein said simulated display fan is imprinted with markings characteristic of a male turkey.

18. The device of claim 17, wherein said simulated display fan is imprinted on a front surface of said simulated display fan with markings characteristic of a male turkey.

19. The device of claim 17, wherein said simulated display fan is imprinted on a back surface of said simulated display fan with markings characteristic of a male turkey.

20. The device of claim 17, wherein a front surface of said simulated display fan is imprinted with a first set of markings characteristic of a male turkey and a back surface of said simulated display fan is imprinted with a second set of markings characteristic of a male turkey.

21. The device of claim 17 wherein said simulated display fan is imprinted with a photographic reproduction of a male turkey display fan.

22. The device of claim 15 wherein said simulated display fan is shaped to a silhouette a display fan of a male turkey.

23. The device of claim 15 wherein said main body is comprises a semi-rigid shell.

24. The device of claim 15 wherein said simulated display fan is collapsible from an open position.

25. The device of claim 20, wherein said decoy further comprises a pivot point defined in said semi-rigid shell proximal a center of gravity of said decoy.

26. The device of claim 21, said decoy further comprising a stake, and said pivot point receives an upper end of said stake to pivotally support said main body above a ground surface.

27. A decoy kit comprising, a main body depicting a strutting male turkey, a simulated display fan of a male turkey removably attachable to said main body at a tail portion thereof, and a stake for pivotally supporting said main body above a ground surface.

28. The kit of claim 23 wherein said main body is a flexible hollow shell.

29. The kit of claim 28 wherein said main body is collabsible from an extended display position for carriage in said carrying bag.

30. The kit of claim 23, wherein said display fan is collapsible from an extended display position for carriage in said carrying bag.

31. The kit of claim 23 further comprising, a second body depicting a female turkey.

32. The kit of claim 24 wherein said second body depicts a female turkey in a receptive mating posture.

33. The kit of claim 23 further comprising a carrying bag for containing the components of said decoy kit.

34. The kit of claim 32 wherein said second body is collapsible from an extended display position for carriage in a carrying bag.
